(19) United States
(12) Patent Application Publication
(10) Pub. No.: US 2014/0252180 A1
(43) Pub. Date: Sep. 11, 2014

(54) SCREEN SUPPORTING DEVICE

(71) Applicants: LITE-ON TECHNOLOGY CORPORATION, TAIPEI CITY (TW); LITE-ON ELECTRONICS (GUANGZHOU) LIMITED, GUANGZHOU (CN)

(72) Inventors: SHU-HUA MAU, TAOYUAN COUNTY (TW); YUE-WEN JIANG, TAOYUAN COUNTY (TW)

(73) Assignees: LITE-ON TECHNOLOGY CORPORATION, TAIPEI CITY (TW); LITE-ON ELECTRONICS (GUANGZHOU) LIMITED, GUANGZHOU (CN)

(21) Appl. No.: 13/969,119

(22) Filed: Aug. 16, 2013

(30) Foreign Application Priority Data
Mar. 6, 2013 (CN) 201310071765.X

(51) Int. Cl. F16M 11/10

(52) U.S. Cl. CPC F16M 11/10
USPC 248/123.11

(57) ABSTRACT

A screen supporting device includes a shaft, a bracket, and a torsion adjusting structure. The bracket and the torsion adjusting structure are pivotally on the shaft. The torsion adjusting structure has a limited washer and a torsion spring. The shaft passes through the limited washer and the torsion spring, and two ends of the torsion spring are respectively inserted into the bracket and the limited washer. Thus, when the bracket pivots by being forced, the shaft and the limited washer maintains the position thereof to cause that the relative position of the ends of the torsional spring, which respectively inserted into the bracket and the limited washer, is changed to provide the bracket with an additional torsion. Therefore, the instant disclosure provides the supporting device capable of the torsion variable function.

### BACKGROUND OF THE INVENTION

1. Field of the Invention

The instant disclosure relates to a supporting device; more particularly, to a screen supporting device providing varying torsion.

2. Description of Related Art

The conventional screen supporting device has washers installed via screws, in which a normal force generated upon screwing presses the washers for providing a constant torsion to the conventional screen supporting device. If the preferred torsion is large, the washer is manufactured larger to conform to the preferred torsion. That is to say, the washer has a larger cross-section.

However, the bracket of the conventional screen supporting device is used for loading a screen, and the torsional demand of the bracket is designed according to the weight of screen. That is to say, the torsion of the conventional screen supporting device is not variable.

Due to the popularity of the touch-control screen, when using the touch-control screen, the screen supporting device may need larger torsion. However, when collapsing the touch-control screen, the screen supporting device needs smaller torsion. Thus, the conventional screen supporting device does not provide adjustable torsion.

To achieve the abovementioned improvement, the inventors strive via industrial experience and academic research to present the instant disclosure, which can provide additional improvement as mentioned above.

### SUMMARY OF THE INVENTION

One embodiment of the instant disclosure provides a screen supporting device for providing a variable torsion according to the force magnitude forced on the bracket.

The screen supporting device in the instant disclosure comprises a base seat; a frame module having two opposite end portions respectively defined as a bottom end portion and a top end portion, wherein the bottom end portion is pivotally coupled to the base seat along a rotational axis; a hinge structure pivotally coupled to the top end portion of the frame module, and comprising: a shaft coupled through the top end portion of the frame module, wherein the shaft has a non-circular cross-section, and a longitudinal direction of the shaft is defined as a central axis parallel to the rotational axis; a bracket for carrying a screen, the bracket having a thru hole and a limited opening, wherein the shaft is inserted into the thru hole of the bracket, and the bracket is pivotable about the shaft along the central axis; and a torsion adjusting structure, comprising: a limited washer including a fixing portion and a positioning opening conforming with the cross-section of the shaft, and the shaft inserted into the positioning opening of the limited washer; and a torsion spring having an elastic portion formed by a spirally-shaped metal and two inserting portions respectively extended from two opposite ends of the elastic portion; wherein the spirally-shaped elastic portion defines a channel therein, the shaft is inserted into the channel of the elastic portion, the two inserting portions have cross-sections respectively conforming with the limited opening of the bracket and the fixing portion of the limited washer, and the two inserting portions are respectively inserted into the limited opening of the bracket and the fixing portion of the limited washer; wherein the shape of the positioning opening of the limited washer is non-circular and correspondingly to the non-circular cross-section of the shaft, the shaft is inserted into the positioning opening of the limited washer such that the limited washer is held in position and the inserting portion of the torsion spring is fixed in the fixing portion of the limited washer, the elastic portion is twisted by the inserting portions of the torsion spring to provide the bracket with an additional torsion based on the torsion spring configured to resist rotation of the bracket.

In summary, the screen supporting device in the instant disclosure is designed with the torsion spring, the bracket, and the limited washer, so that when rotating the bracket, the torsion spring provides the bracket with the additional torsion.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a perspective view of a screen supporting device according to the instant disclosure;

FIG. 2 is a partially exploded view of the screen supporting device according to the instant disclosure;

FIG. 3 is a partially cross-sectional view illustrating a bracket (not rotated) of the screen supporting device according to the instant disclosure;

FIG. 4 is another partially cross-sectional view illustrating the bracket (rotated) of the screen supporting device according to the instant disclosure;

FIG. 5 is another partially cross-sectional view illustrating the bracket (rotated toward another direction with respect to the direction shown in FIG. 3) of the screen supporting device according to the instant disclosure;

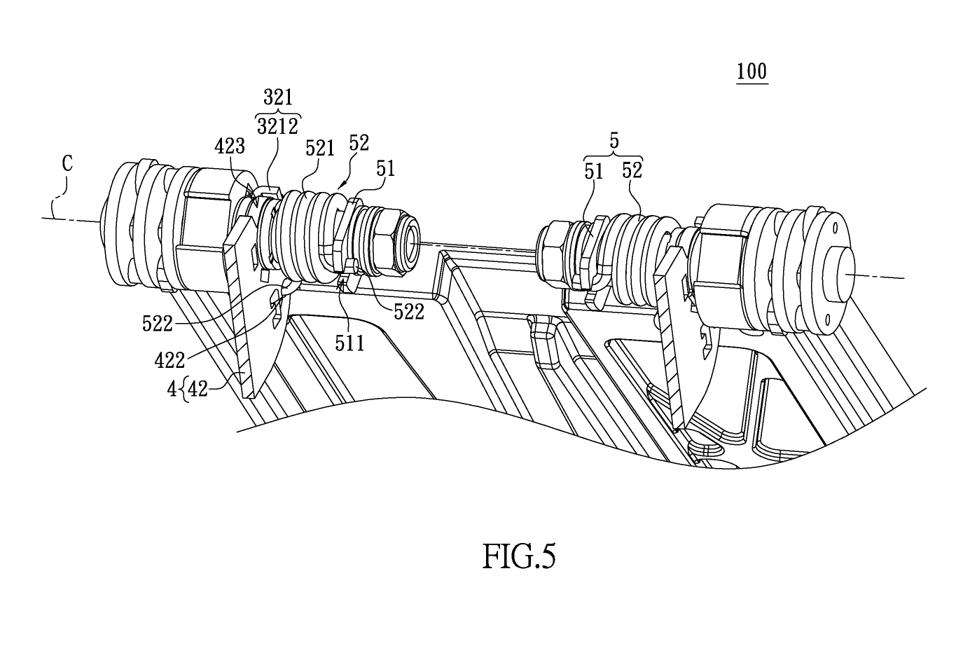

FIG. 6 is a perspective view of the folded screen supporting device according to the instant disclosure; and

FIG. 7 is a partially cross-sectional view of the screen supporting device according to another embodiment of the instant disclosure.

### DETAILED DESCRIPTION OF THE PREFERRED EMBODIMENTS

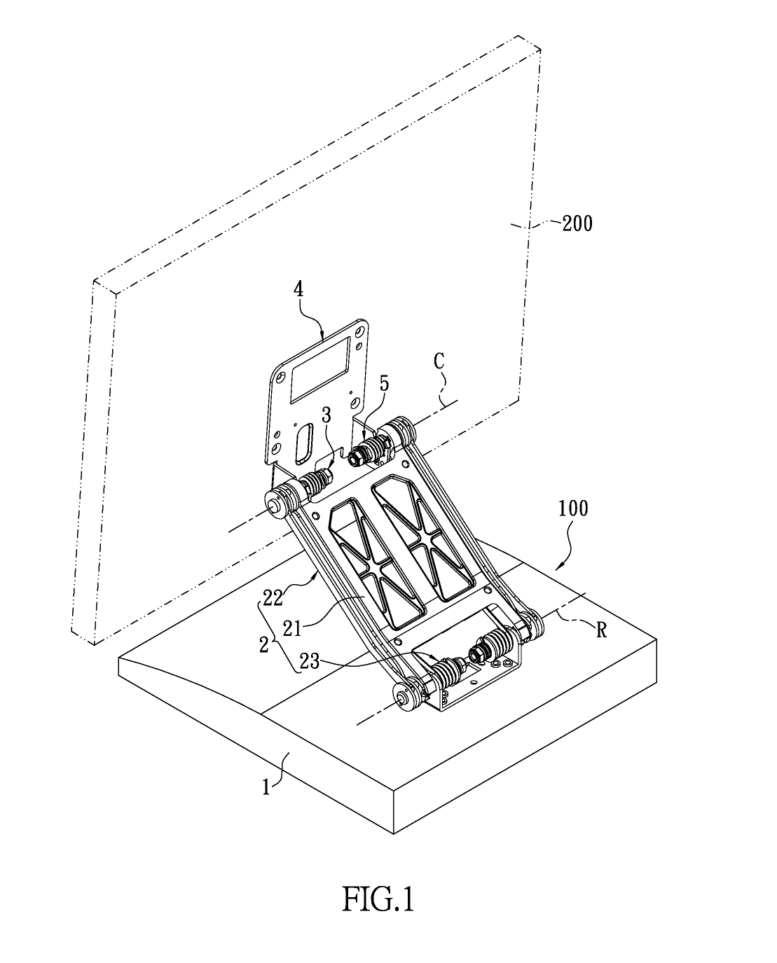

Please refer to FIG. 1, which shows an embodiment of the instant disclosure. The instant embodiment provides a screen supporting device 100 applied to support a screen 200 (e.g., touch-control screen). The screen supporting device 100 includes a base seat 1, a frame module 2, two hinge structures 3, a bracket 4, and a torsion adjusting structure 5.

The following description discloses the construction of each component and the relationship between the components of the screen supporting device 100 firstly, and then discloses the operating condition and the using state of the screen supporting device 100.

The base seat 1 can be disposed on a working surface (e.g., desktop). Two opposite end portions of the frame module 2 are respectively defined as a bottom end portion and a top end portion. The bottom end portion of the frame module 2 is pivotally coupled to one end of the base seat 1 (i.e., the left-lower end of the base seat 1 as shown in FIG. 1) along a rotational axis R. The top end portion of the frame module 2 is pivotally coupled to the hinge structures 3, the bracket 4, and the torsion adjusting structure 5.

Specifically, the frame module 2 includes a main shaft 21 being substantially a H-shaped contour and having two four-bar linkages 22, and two pivoting units 23. Each pivoting unit 23 has a torsion spring. The four-bar linkages 22 are respectively disposed on two opposite lateral sides of the main shaft 21 (i.e., the left side and the right side of the main body 21 as shown in FIG. 1). The bottom portion of the main shaft 21 and the bottom portion of each four-bar linkage 22 are pivotally coupled to the base seat 1 along the rotational axis R for allowing the frame module 2 to rotate with respect to the base seat 1 along the rotational axis R.

Moreover, because the pivoting relationship between the frame module 2 and the base seat 1 is not the important feature in the instant disclosure, so that the instant embodiment does not disclose the detail construction of the pivoting relationship. Furthermore, the four-bar linkage 22 can be parallel or non-parallel based on preference, the type of the four-bar linkage 22 is not limited thereto.

The hinge structures 3 are respectively and pivotally coupled to two opposite sides of the top end portion of the frame module 2 (i.e., the left side and the right side of the top end portion of the frame module 2 as shown in FIG. 1). Because the hinge structures 3 are identical, the following figures only show an exploded view of one of the hinge structures 3.

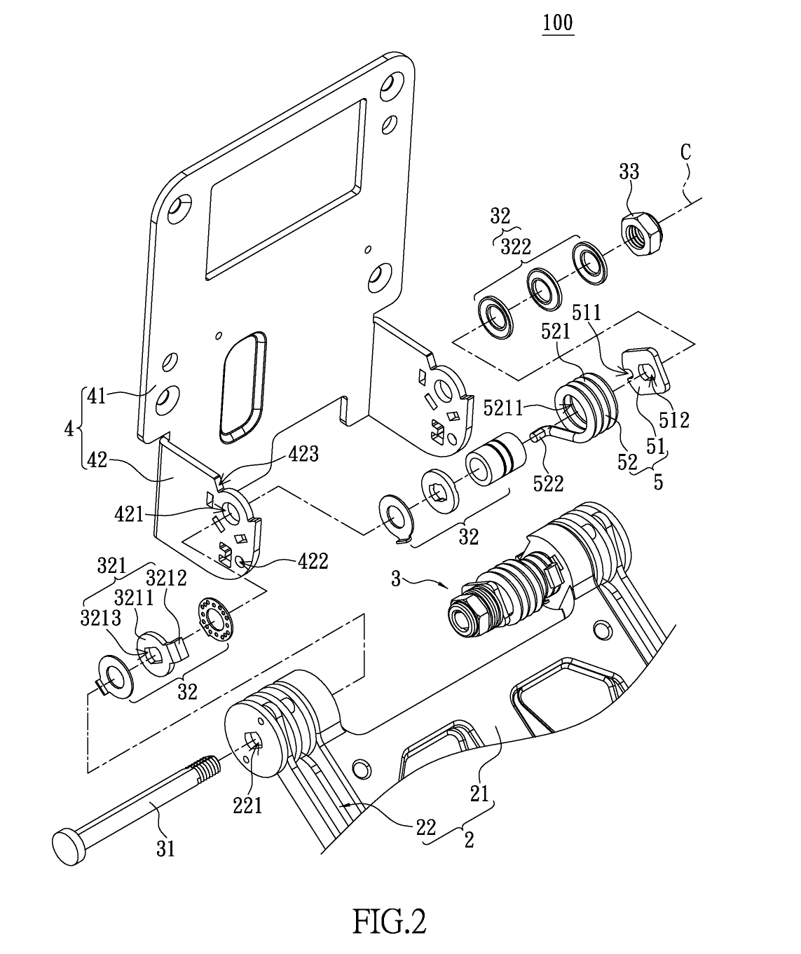

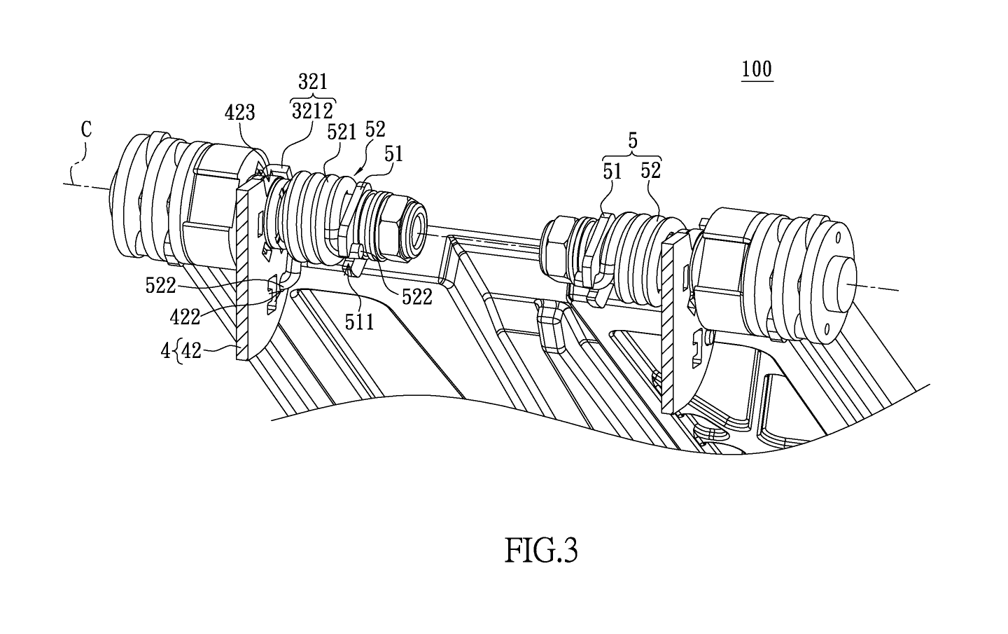

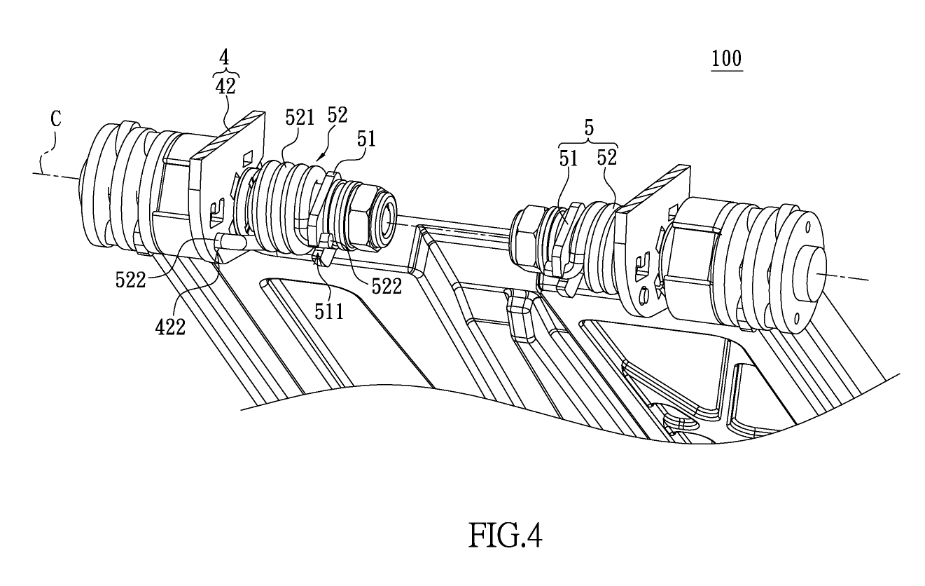

Specifically, please refer to FIGS. 2 and 3, and with reference occasionally made to FIG. 4. Each hinge structure 3 includes a shaft 31 and a washer assembly 32. The shaft 31 exhibits a non-circular cross-section (i.e., the cylinder are flattened along the longitudinal direction), and the longitudinal direction of the shaft 31 is defined as a central axis C.

Two shafts 31 are respectively coupled through the two opposite sides of the top end portion of the frame module 2. The top end portion of the frame module 2 is the top portion of the main shaft 21 and the top portion of each four-bar linkage 22. The central axes C of the two shafts 31 overlap, that is to say, each shaft 31 falls on the same axis C and the central axes C are regarded as one central axis C. The central axis C is substantially parallel to the rotational axis R.

Specifically, the top portion of each four-bar linkage 22 has a non-circular positioning opening 221 (as shown in FIG. 2) conforming in shape with the cross-section of each shaft 31. The shafts 31 respectively couple through the positioning openings 221 of the four-bar linkages 22 such that the frame module 2 supports the shafts 31.

Each washer assembly 32 has a plurality of washers, and the washer assemblies 32 are respectively sleeved on the shafts 31 along the central axis C. A nut 33 is screwed on an end portion of each shaft 31. The type of the washer assembly 32 can be changed according to preference, and the instant embodiment is not intended to limit the instant disclosure as illustrated or described herein. Particularly, each washer assembly 32 has a latching washer 321. The latching washer 321 has a sheet body 3211 and a latching flange 3212 integrally formed with the sheet body 3211. The latching flange 3212 is extended and bent from the sheet body 3211. The sheet body 3211 is formed with a positioning opening 3213 on a central portion thereof. The positioning opening 3213 conforms to the cross-section of the shaft 31. The shafts 31 are respectively inserted into the positioning openings 3213 of the latching washers 321 along the central axis C for maintaining the relative position between each latching washer 321 and each corresponding shaft 31.

The bracket 4 is plate-like and has a support plate 41 and two connecting portions 42. The support plate 41 is used to provide the installation of the screen 200. The connecting portions 42 are respectively extended and bent from two opposite sides of a bottom portion of the support plate 41.

Moreover, each of the connecting portions 42 is formed with a thru hole 421 and a limited opening 422 on a portion of the connecting portion 42. The thru holes 421 align with one another and the openings 422 align with one another. Each connecting portion 42 is formed with an arc groove 423 proximate to the thru hole 421. The shafts 31 are respectively inserted into the thru holes 421 of the connecting portions 42 along the central axis C such that the bracket 4 can rotate about the shafts 31 along the central axis C.

Specifically, the connecting portions 42 are arranged between the latching washers 321 and respectively pressing against the latching washers 321. The latching flanges 3212 of the latching washers 321 are respectively received by the arc grooves 423, so that when the bracket 4 is rotating, the rotatable angle of the bracket 4 is restricted by each latching flange 3212 abutting two opposite end walls of the corresponding arc groove 23. That is to say, the rotatable angle range of the bracket 4 is approximately identical to the arc angle of the arc groove 423.

The torsion adjustable structure 5 includes two limited washers 51 and two torsion springs 52 respectively coupled to the limited washers 51. Each limited washer 51 includes a fixing portion 511 and a positioning opening 512 conforming with the cross-section of the shaft 31. In particular, the fixing portion 511 in the instant embodiment is a notch concavely formed on an edge of the limited washer 51, but in an embodiment (not shown), the fixing portion 511 can be a thru hole. The positioning opening 512 is formed proximate to a central portion of the limited washer 51.

Each torsion spring 52 includes an elastic portion 521 and two inserting portions 522 respectively extended from two opposite ends of the elastic portion 521 (i.e., the left-lower end of elastic portion 521 and the right-upper end of the elastic portion 521 as shown in FIG. 3) in opposite directions. The elastic portion 521 is spirally-shaped and made of metal. Moreover, each spirally-shaped elastic portion 521 defines a channel 5211 therein, and the cross-sections of the two inserting portions 522 of each torsion spring 52 respectively conform to the limited opening 422 of the bracket 4 and the fixing portions 511 of the limited washer 51.

The shafts 31 are respectively inserted into the channels 5211 of the elastic portions 521 along the central axis C. One of the inserting portions 522 of each torsion spring 51 is inserted into the corresponding limited opening 422 of the bracket 4, the shafts 31 are respectively inserted into the positioning openings 512 of the limited washers 51, and another inserting portion 522 of each torsion spring 51 is inserted into the fixing portion 511 of the adjacent limited washer 51 for preventing the inserting portion 522 from sliding out of the notch-like fixing portion 511. Specifically, each torsion spring 52 and the corresponding limited washer 5 are arranged at an inner side of the adjacent connecting portion 42 and clipped between two washers (not labeled) of the corresponding washer assembly 32.

Base on the above, when the bracket 4 is forced to rotate, the positions of the shafts 31 and the limited washer 51 sleeved at the shafts 31 remains still, and the relative position of the inserting portions 522 of each torsion spring 52 varies such that each elastic portion 521 is twisted by the corresponding inserting portions 522, thereby providing the bracket 4 with an additional torsion. That is to say, after each shaft 31 is inserted into the positioning opening 512 of the corresponding limited washer 51, the position of each limited washer 51 is fixed which provides constrain to the inserting portion 522 of each torsion spring 52 (at such time, the inserting portion 522 is inserted into the fixing portion 511 of the corresponding limited washer 51). Furthermore, each elastic portion 521 is twisted by the corresponding inserting portions 522 to provide the bracket 4 with the additional torsion based on each torsion spring 52 configured to resist rotation of the bracket 4.

Specifically, the elastic portion 521 of the torsion spring 52 can provide additional torsion by the displacement between the inserting portions 522. As a result, the additional torsion varies and when the bracket 4 is under various forces, the torsion spring 52 per se provide a corresponding and additional torsion such that the torsion spring 52 can be fixed at a preferred position. For example, the spirally-shaped elastic portion 521 has a spiral axis defined along the spirally extending direction of the elastic portion 521, the spiral axis extends towards two ends of the elastic portion 521. When the inserted portion 522 of the torsion spring 52 inserted into the opening 422 of the bracket 4 is displaced to cause the spiral axis to be tight (i.e. such as the bracket 4 rotating away from the user as shown in FIG. 3 along with FIG. 4), each elastic portion 521 is tightened to provide the bracket 4 with a relatively larger torsion. When the inserted portion 522 of each torsion spring 52 inserted into the corresponding opening 422 of the bracket 4 is displaced to cause the spiral axis to be loose (i.e., such as the bracket 4 rotating toward the user as shown in FIG. 3 along with 5), each elastic portion 521 is relaxed to provide the bracket 4 with a relatively smaller torsion. Thus, when the user's finger touches the screen 200 (i.e., the bracket 4 rotating away from the user), each elastic portion 521 provides the bracket 4 with a relatively large torsion which resists the finger's force, thus preventing the screen 200 from shaking.

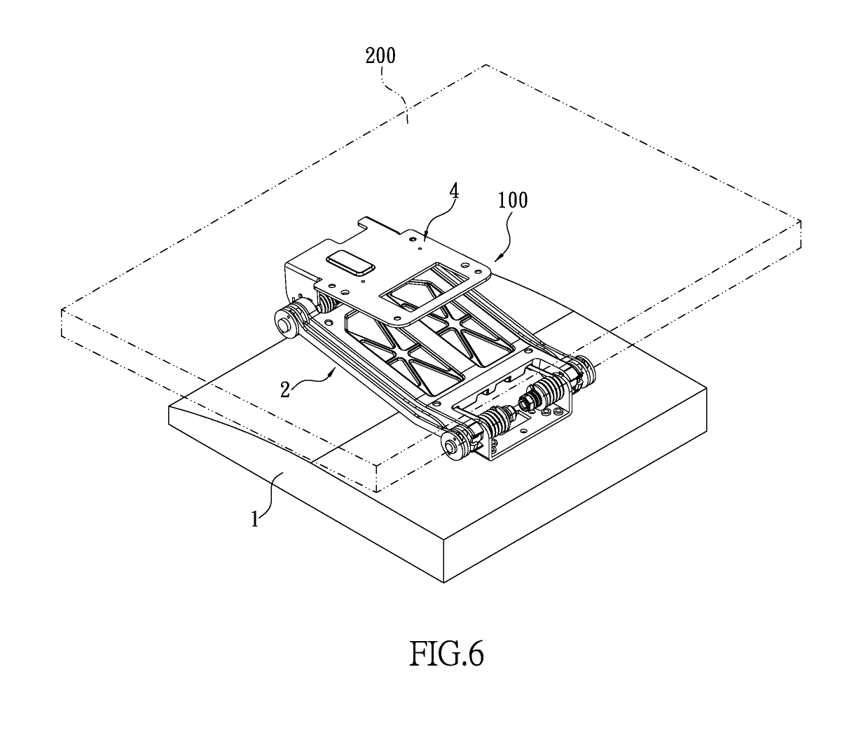

Moreover, if the user prefers to fold the screen supporting device 100, the bracket 4 and the frame module 2 can be fold toward the base seat 1 as in a folded mold shown in FIG. 3, thereby providing a different operating mode of the screen supporting device 100. If the user prefers to adjust the screen supporting device 100 from the position as shown in FIG. 6 to the position as shown in FIG. 1, the user may provide a force to the screen 200 in order to rotate the bracket 4 toward the user, at this moment, each torsion spring 52 provides the bracket 4 with a relatively smaller torsion, so that the user can easily adjust the position of the screen 200 with less force.

Additionally, each washer assembly 32 in the instant embodiment includes three convex washers 322 (as shown in FIG. 2). The convex washers 322 are disposed on one side of the corresponding limited washer 51 away from the adjacent elastic portion 521, and two opposite sides of the three convex washers 322 respectively press against the corresponding limited washer 51 and the corresponding nut 33. A contact area between the convex washer 322 and the corresponding limited washer 51 is adjustable according to the degree of compression of the convex washer 322 (for example: the torque between the nut 33 screwed onto the shaft 31) in order to provide the bracket 4 with different torsions.

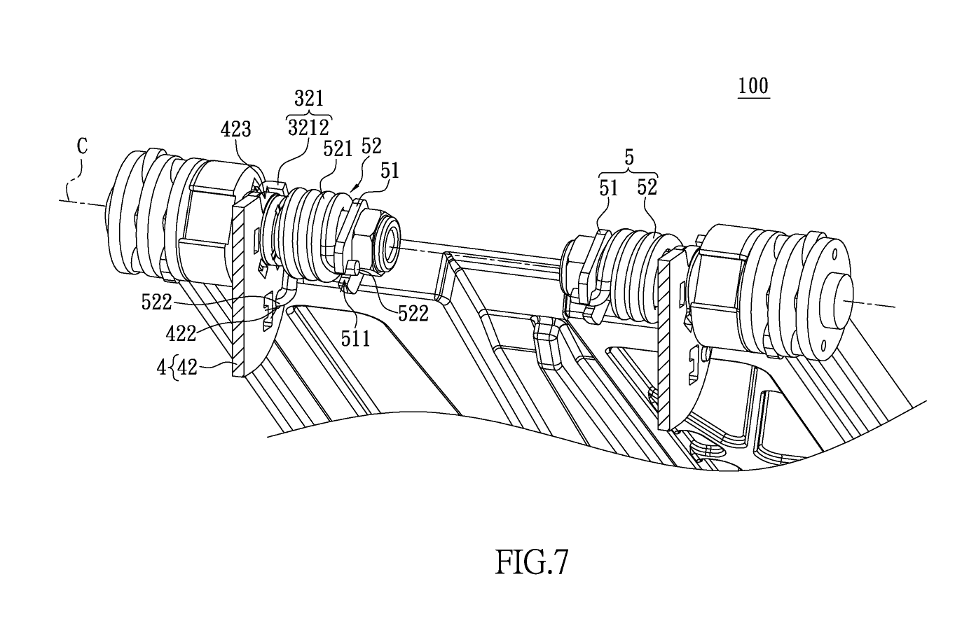

Please refer to FIG. 7, the washer assembly 32 can be configured without the convex washer 322. The nut 33 is screwed on the end portion of the shaft 31 to press against the limited washer 51. A contact area between the nut 33 and the limited washer 51 is adjustable according to the degree of compression between the nut 33 and the limited washer 51 to provide the bracket 4 with variable torsion.

### [The Possible Effects of the Instant Embodiment]

In summary, the screen supporting device in the instant disclosure is designed with the torsion adjusting structure and the cooperation of the torsion springs, the bracket, and the limited washers, so that when the bracket is forced to rotate by different power, the additional torsion is variable for enabling the torsion spring to obtain a suitable additional torsion to stop at a predetermined position.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A screen supporting device, comprising:
a base seat;
a frame module having two opposite end portions respectively defined as a bottom end portion and a top end portion, wherein the bottom end portion is pivotally coupled to the base seat along a rotational axis;
a hinge structure pivotally coupled to the top end portion of the frame module and comprising:
a shaft coupled through the top end portion of the frame module, wherein the shaft has a non-circular cross-section, and a longitudinal direction of the shaft is defined as a central axis parallel to the rotational axis;
a bracket for carrying a screen, the bracket having a thru hole and a limited opening, wherein the shaft is inserted into the thru hole of the bracket, and the bracket is pivotable about the shaft along the central axis; and
a torsion adjusting structure, comprising:
a limited washer including a fixing portion and a positioning opening conforming with the cross-section of the shaft, and the shaft inserted into the positioning opening of the limited washer; and
a torsion spring having an elastic portion formed by a spirally-shaped metal and two inserting portions respectively extended from two opposite ends of the elastic portion; wherein the spirally-shaped elastic portion defines a channel therein, the shaft is inserted into the channel of the elastic portion, the two inserting portions have cross-sections respectively conforming with the limited opening of the bracket and the fixing portion of the limited washer, and the two inserting portions are respectively inserted into the limited opening of the bracket and the fixing portion of the limited washer;
wherein the shape of the positioning opening of the limited washer is non-circular and correspondingly to the non-circular cross-section of the shaft, the shaft is inserted into the positioning opening of the limited washer such that the limited washer is held in position and the inserting portion of the torsion spring is fixed in the fixing portion of the limited washer, the elastic portion is twisted by the inserting portions of the torsion spring to provide the bracket with an additional torsion based on the torsion spring configured to resist rotation of the bracket.

2. The screen supporting device according to claim 1, wherein the bracket has a support plate and a connecting portion bendingly extended from the support plate, and wherein the support plate is adapted to install the screen, the thru hole and the limited opening are formed on the connecting portion.

3. The screen supporting device according to claim 2 further comprising a washer assembly sleeved on the shaft; wherein the washer assembly includes a latching washer having a latching flange, the latching washer has portions defining a positioning opening conforming to the cross-section of the shaft, the shaft is fitted in the positioning opening of the latching washer, and an edge of the connecting portion has an arc groove arranged thereon proximate to the thru hole, the latching flange of the latching washer is received by the arc groove such that a rotatable angle range of the bracket is substantially identical to an arc angle range of the arc groove.

4. The screen supporting device according to claim 1, wherein the hinge structure includes a nut screwed on an end portion of the shaft, a contact area between the nut and the limited washer is adjustable according to the degree of compression between the nut and the limited washer in order to provide the bracket with different torsions.

5. The screen supporting device according to claim 4, further comprising a washer assembly sleeved on the shaft, wherein the washer assembly includes a plurality of convex washers, the convex washers are disposed on one side of the limited washer away from the elastic portion and pressed against the limited washer, and a contact area between the convex washers and the limited washer is adjustable according to the degree of compression the convex washer underwent in order to provide the bracket with different torsions.

6. The screen supporting device according to claim 5, wherein the convex washers are arranged between the nut and the limited washer, the degree of compression the convex washers underwent is adjustable according to a force generated from the nut screwing to the shaft.

7. The screen supporting device according to claim 1, wherein the spirally-shaped elastic portion has a spiral axis defined along the spirally extending direction of the elastic portion, the spiral axis extends towards two ends of the elastic portion, and wherein when the inserted portion of the torsion spring inserted into the limited opening of the bracket is displaced to cause the spiral axis to be tight, the elastic portion is tightened to provide the bracket with a relatively larger torsion; when the inserted portion of the torsion spring inserted into the limited opening of the bracket is displaced to cause the spiral axis to be loose, the elastic portion is relaxed to provide the bracket with a relatively smaller torsion.

8. The screen supporting device according to claim 1, wherein the frame module includes a main shaft, a four-bar linkage, and a pivoting unit, the four-bar linkage is arranged on a side of the main shaft, an bottom portion of the main shaft and an bottom portion of the four-bar linkage are pivotally coupled to the base seat along the rotational axis such that the frame module rotates about the base seat along the rotational axis.

9. The screen supporting device according to claim 1, wherein the fixing portion is concavely formed on an edge of the limited washer.

10. The screen supporting device according to claim 1, wherein the top end portion of the frame module has a non-circular positioning opening conforming to the cross-section of the shaft, and the shaft is coupled through the positioning opening of the top end portion of the frame module such that the shaft is supported by the frame module.
